(19) United States
(12) Patent Application Publication
(10) Pub. No.: US 2009/0184134 A1
(43) Pub. Date: Jul. 23, 2009

(54) Foam dispenser with liquid tube pump refill unit

(76) Inventors: Nick E. Ciavarella, Seven Hills, OH (US); David D. Hayes, Wooster, OH (US); Aaron R. Reynolds, North Canton, OH (US)

Correspondence Address: Mark L. Weber;Fourth Floor, First National Tower, Akron, OH, 44308-1456, US

(21) Appl. No.: 12/009,531

(22) Filed: Jan. 18, 2008

(51) Int. Cl. B67D 5/58; B67D 5/52; B65D 37/00

(52) U.S. Cl. 222/135; 222/190; 222/214; 222/207

(57) ABSTRACT

A foam dispenser includes a housing and a refill unit. The refill unit carries a tube pump for pumping a foamable liquid, and the housing carries an air pump for pumping air. The tube pump and air pump fluidly communicate premixed chamber in a mixing unit to create a foam product when the dispenser is actuated to actuate both the 2 pump and the air pump.

### TECHNICAL FIELD

The invention herein resides in the art of foam dispensers wherein a foamable liquid and air are combined to dispense a foam product. More particularly, the invention relates to a dispenser wherein a liquid tube pump is provided as part of a disposable refill unit containing the liquid, and an air pump is provided as part of the dispenser housing.

### BACKGROUND OF THE INVENTION

For many years, it has been known to dispense liquids, such as soaps, sanitizers, cleansers, disinfectants, and the like from a dispenser housing maintaining a refill unit that holds the liquid and provides the pump mechanisms for dispensing the liquid. The pump mechanism employed with such dispensers has typically been a liquid pump, simply emitting a predetermined quantity of the liquid upon movement of an actuator. Recently, for purposes of effectiveness and economy, it has become desirable to dispense the liquids in the form of foam, generated by the interjection of air into the liquid. Accordingly, the standard liquid pump has given way to a foam generating pump, which necessarily requires means for combining the air and liquid in such a manner as to generate the desired foam. However, foam generating pumps are more expensive than liquid dispensing pumps, necessarily increasing the cost of a refill unit that includes the pump mechanism.

Typically, foam pumps include an air pump portion and a fluid pump portion—the two requiring communication to ultimately create the foam. It has been found that the air pump portion required for pumping the air does not wear out and degrade as quickly as the liquid pump portion required for pumping the liquid. Additionally, the air pump portion mainly comes into contact with air and thus stays more sanitary, making its periodic replacement less necessary than in the case of the liquid pump portion and the foam generating portion of a foam dispenser. Accordingly, it has been determined that it is not as necessary to replace the air pump as it is to replace the liquid pump and foam generating portion of the dispenser when replacement of the refill unit is necessary. Accordingly, there is a need in the art for foam dispensing systems that employ a disposable liquid pump and a more permanent air pump.

### SUMMARY OF THE INVENTION

In light of the foregoing, this invention provides a dispenser including a housing and a refill unit. The housing includes an air bellows having and expanded volume and a compressed volume and retaining its expanded volume when the dispenser is not being actuated. The housing further includes a container support, a pump anvil, and a push bar. The push bar provides a pump plate portion and an air bellows actuator, and is capable of reciprocal movement toward and away from the pump anvil. The refill unit includes a container holding a foamable liquid, and a tube pump fluidly communicating with the foamable liquid in the container. The tube pump includes a collapsible tube, and the flow of foamable liquid into and out of the collapsible tube is regulated by a tube pump inlet valve and a tube pump outlet valve. The container fluidly communicates with the collapsible tube through the tube pump inlet valve. The refill unit further includes a mixing unit, and the collapsible tube communicates with the mixing unit through the tube pump outlet valve. The mixing unit includes an air bellows adaptor that is secured to an air outlet of the air bellows to fluidly communicate with the air bellows through an air bellows valve. The dispenser is actuated by moving the push bar toward the pump anvil, with such movement squeezing the collapsible tube between the push plate portion and the pump anvil to force foamable liquid therein through the tube pump outlet valve and into the mixing unit, such movement also causing the air bellows actuator to move the air bellows to its compressed volume to force air therein through the air bellows outlet valve and into the mixing unit.

Although the various elements of the dispenser as summarized above include particular elements as part of either a housing or a refill unit, this invention is not limited thereto or thereby, and it should be appreciated that the various dispenser elements may be provided in other ways, provided the various elements interact and function as taught herein.

### DESCRIPTION OF THE DRAWINGS

FIG. 1 is cross sectional view of an embodiment of a dispenser of this invention; and

FIG. 2 is a cross sectional view of a mixing cartridge.

### DETAILED DESCRIPTION OF THE INVENTION

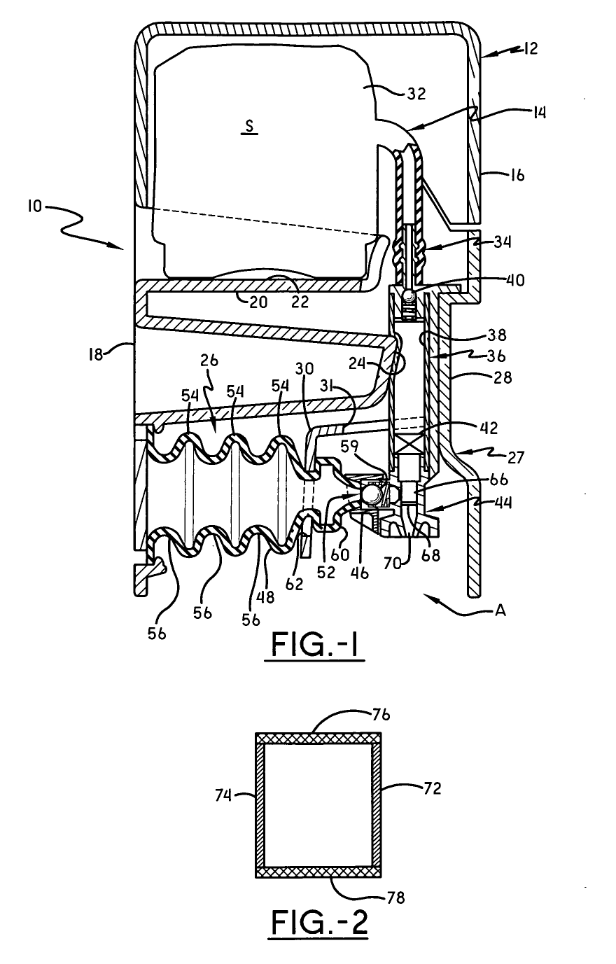

With reference to FIG. 1, the dispenser of this invention is shown and designated by the numeral 10. The dispenser 10 includes a housing 12 adapted to receive and hold a refill unit 14. Although the housing may take other forms, in this embodiment, the housing 12 is of the common type that includes a cover 16 secured to a backplate 18. A container support 20 is provided as part of backplate 18, here, in the form of a ledge 22. A pump anvil 24 is provided below the ledge 22, and an air bellows 26 extends outwardly from backplate 18 below the pump anvil 24. The cover 16 includes a push bar 27, which, when the cover 16 is closed on backplate 18, aligns over both the pump anvil 24 and the air bellows 26. More particularly, the push bar 27 provides a pump plate portion 28, which aligns with the pump anvil 24, and an air bellows actuator 30 that extends toward and connects to air bellows 26.

The refill unit 14 provides a container 32 holding a foamable liquid S. It is a collapsible container as known in the art. The container 32 is placed in the housing 12 on the container support 20. A dispensing tube 34 extends down from the container 16, and feeds foamable liquid S from container 16 to a tube pump 36. The tube pump 36 includes a collapsible tube 38 positioned between the pump anvil 24 and the push plate portion 28 of the push bar 27 and is preferably secured to push bar 27 to move therewith. A tube pump inlet valve 40 regulates flow of the foamable liquid S into the collapsible tube 38, and a tube pump outlet valve 42 regulates the flow of foamable liquid S out of the collapsible tube 38 and into a mixing unit 44. These valves are shown as common spring biased ball valves, but other valves may be used to join with an air source. The mixing unit 44 includes an air bellows adaptor 46 extending to mate with the air bellows 26.

The air bellows 26 includes a bellows body 48 that is sealed to backplate 18 at base 50, and is open at outlet 52. The bellows body 48 is corrugated, as at ridges 54 and valleys 56, and is made of a material that provides the bellows body 48 with the ability to reversibly collapse and extend between a compressed volume and an expanded volume. The air bellows adaptor 46 of the mixing unit 44 is sealed around the outlet 52 of the air bellows 26, and the air bellows 26 fluidly communicates with the mixing unit 44 through an air bellows valve 59 (again as a ball valve, though not limited thereto) provided as part of the mixing unit 44.

The air bellows actuator 30 extends toward air bellows 26 and bypasses the tube pump 36 at an aperture 31. A mount ridge 60 of bellows body 48 is fed through an aperture 62 in the air bellows actuator 30 so that the air bellows actuator 30 will impact the first ridge 54 when urged in the direction of arrow A.

When the refill unit 14 is properly mounted in the housing 12 and the cover 16, the dispenser 10 is actuated to dispense a foam product by moving the push bar 27 in the direction of arrow A. By moving the push bar 27 in the direction of arrow A, the collapsible tube 38 is squeezed between the push plate portion 28 of the push bar 27 and the pump anvil 24. This forces foamable liquid in the collapsible tube 38 through the tube pump outlet valve 42 and into the mixing unit 44. This movement of the push bar 27 also causes the air bellows actuator 30 to press against the first ridge 54 of the bellows body 48, thus compressing the air bellows 26 to its compressed volume to force air therein through the outlet 52 of air bellows 46 and through the air bellows valve 59 into the premix passage 66 of the mixing unit 44. Thus, foamable liquid S and air mix at the premix chamber 66 to form a coarse mixture. During actuation, this coarse mixture is forced through a mesh screen 68 to homogenize mixture and create a high quality foam product that is dispensed at the outlet 70. As can be seen in FIG. 2 the mesh screen 68 can be replaced with a mixing cartridge 72, which includes a hollow tube 74 bounded on both ends by mesh screens 76 and 78.

In light of the foregoing, it should be apparent that the present invention improves the art by providing a foam dispenser having a liquid tube pump refill unit that is separate and distinct from an air pump unit, namely an air bellows. While a particular embodiment of this invention has been the focus for purposes of disclosing the invention, it should be appreciated that this invention can be modified in various ways without departing from the general concepts taught herein. Thus, this invention is not to be limited to or by any particular embodiment, rather, the claims will serve to define the invention.

1. A dispenser comprising:
an air bellows having an expanded volume and a compressed volume and retaining said expanded volume when said dispenser is not being actuated, said air bellows providing an air outlet,
a pump anvil, and
a push bar having a push plate portion and an air bellows actuator, said push bar being capable of reciprocal movement toward and away from said pump anvil; and
a container holding a foamable liquid,
a mixing unit having an air bellows adaptor secured to said air outlet of said air bellows to fluidly communicate with said air bellows,
a tube pump including:
a collapsible tube positioned between said pump anvil and said push plate portion of said push bar, said collapsible tube portion adapted to receive foamable liquid from said container and to fluidly communicate with said mixing unit;
wherein the dispenser is actuated by moving said push bar toward said pump anvil, with such movement squeezing said collapsible tube between said push plate portion and said pump anvil to force foamable liquid therein into said mixing unit, such movement also causing said air bellows actuator to move said air bellows to its compressed volume to force air therein into said mixing unit.

2. The dispenser of claim 1 wherein the air bellows, pump anvil, and push bar are provided as part of a housing, and wherein the container, mixing unit, and tube pump are provided as part of refill unit separate and distinct from said housing.

3. The dispenser of claim 1, wherein said housing further comprises a container support, said container being mounted on said container support of said housing.

4. The dispenser of claim 1, further comprising an air bellows valve regulating air flow from said air bellows, through said air bellows valve, and into said mixing unit.

5. The dispenser of claim 1, wherein said tube pump further includes:
a tube pump inlet valve, said container fluidly communicating with said collapsible tube through said tube pump inlet valve, and
a tube pump outlet valve, said collapsible tube fluidly communicating with said mixing unit through said tube pump outlet valve.

6. A refill unit for a dispenser that provides at least a portion of an air pump, the refill unit comprising:
(a) a container holding a foamable liquid;
(b) a tube pump including:
a collapsible tube,
a tube pump inlet valve, and
a tube pump outlet valve, said collapsible tube fluidly communicating with said container through said tube pump inlet valve, said tube pump inlet valve regulating the flow of foamable liquid from said container into said collapsible tube; and
(c) a mixing unit configured to selectively mate with the at least a portion of an air pump provided by the dispenser, said collapsible tube fluidly communicating with said mixing unit through said tube pump outlet valve.

7. A dispenser for a foam product in which air and a foamable liquid are mixed to create the foam product, the dispenser comprising:
a dispenser housing providing at least a portion of an air pump;
a replaceable refill unit selectively received in said dispenser housing, said refill unit including a container of foamable liquid and a liquid pump for pumping foamable liquid from said container, said refill unit selectively mating with said at least a portion of an air pump provided by said dispenser housing to thereby associate said liquid pump with said at least a portion of an air pump, such that, upon actuation of the dispenser, air and foamable liquid are mixed to create a foam product.

8. In a dispenser including a dispenser housing and a refill unit wherein an air pump and a foamable liquid pump are actuated to advance air and foamable liquid to a common mixing chamber fluidly communicating with both said foamable liquid pump and said air pump, the improvement comprising:
associating the foamable liquid pump with the refill unit and the air pump with the dispenser housing such that the refill unit must be mated with the air pump of the dispenser in order that actuation of the dispenser will advance air and foamable liquid to the common mixing chamber.
